(19) United States
(12) Patent Application Publication
(10) Pub. No.: US 2011/0162215 A1
(43) Pub. Date: Jul. 7, 2011

(54) LETTER OPENER

(76) Inventor: Hsiu-Man Yu Chen, Taichung County (TW)

(21) Appl. No.: 12/651,458

(22) Filed: Jan. 1, 2010

(51) Int. Cl. B26B 29/00

(52) U.S. Cl. 30/286

(57) ABSTRACT

A letter opener includes a main body, a fixing member and a blade. The main body has a cutting opening, a notch, and a trough communicating with the cutting opening and the notch. The fixing member is secured in the notch of the main body. The blade is connected to the fixing member and located in the trough. The blade is exposed in the cutting opening. Thereby, when the cutting edges of the blade are abraded, the blade can be replaced with a new one by disengaging the fixing member from the notch. It is only required to replace the blade, without throwing away the main body. The letter opener of the present invention is cost-effective and environmentally friendly.

### BACKGROUND OF THE INVENTION

1. Field of the Invention

The present invention relates to a letter opener.

2. Description of the Prior Art

A letter opener is used to open an envelope. A conventional letter opener has a main body for grasp. One end of the main body is provided with a blade to open an envelope so as to avoid the letter from being damaged. The blade of the conventional letter opener is fixed to the main body. When the blade is abraded, the whole letter opener is thrown away. This way is not cost-effective and environmentally friendly. Besides, the blade is exposed outside the main body, which may hurt the user's hands easily. Accordingly, the inventor of the present invention has devoted himself based on his many years of practical experiences to solve this problem.

### SUMMARY OF THE INVENTION

The present invention is to provide a letter opener which comprises a main body, a fixing member and a blade. The main body has a top surface, a bottom surface, a cutting opening disposed at one end of the main body close to the bottom surface, a notch disposed close to the top surface, and a trough disposed between the cutting opening and the notch. The trough communicates with the cutting opening and the notch. The fixing member includes a positioning block at one end thereof and an engaging portion at an opposite end thereof. The fixing member is secured in the notch of the main body. The positioning block is inserted in the trough. The blade has a pair of cutting edges at two sides thereof. The blade has a positioning hole corresponding to the positioning block of the fixing member for the blade to be connected to the fixing member and inserted in the through of the main body along with the fixing member. One of the pair of cutting edges of the blade is exposed inside the cutting opening. Thereby, when the cutting edges of the blade are abraded, the blade can be replaced with a new one by disengaging the fixing member from the notch. It is only required to replace the blade, without throwing away the main body. The letter opener of the present invention is cost-effective and environmentally friendly. The blade is accommodated in the trough to prevent the user from being hurt when in use or during carrying.

### BRIEF DESCRIPTION OF THE DRAWINGS

FIG. 1 is a perspective view of a preferred embodiment of the present invention;

FIG. 2 is an exploded view of the preferred embodiment of the present invention;

FIG. 3 is a cross-sectional view of the preferred embodiment of the present invention;

FIG. 4 is a side view showing the blade connected to the fixing member of the preferred embodiment of the present invention;

FIG. 5 is a schematic view showing that the letter opener of the preferred embodiment of the present invention is used to open an envelope;

FIG. 6 is a schematic view showing that the letter opener of the preferred embodiment of the present invention is used to open a carton; and

FIG. 7 is a schematic view showing that the blade of the preferred embodiment of the present invention is reversed.

### DETAILED DESCRIPTION OF THE PREFERRED EMBODIMENTS

Embodiments of the present invention will now be described, by way of example only, with reference to the accompanying drawings.

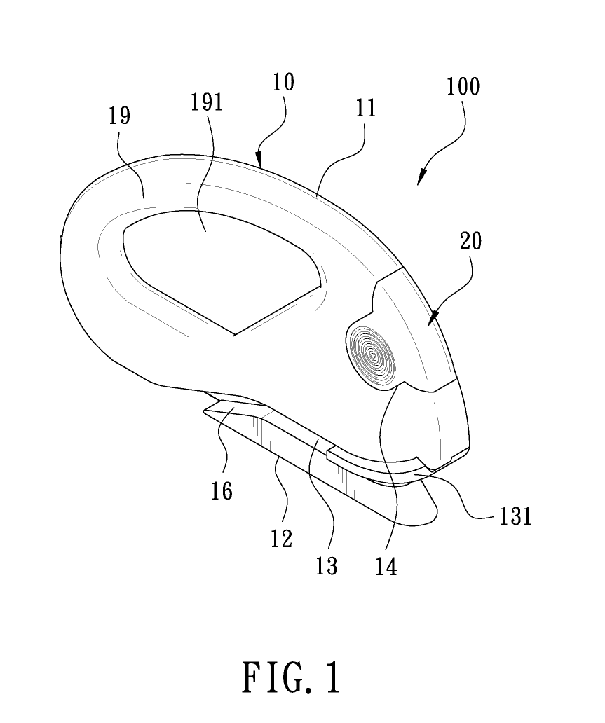

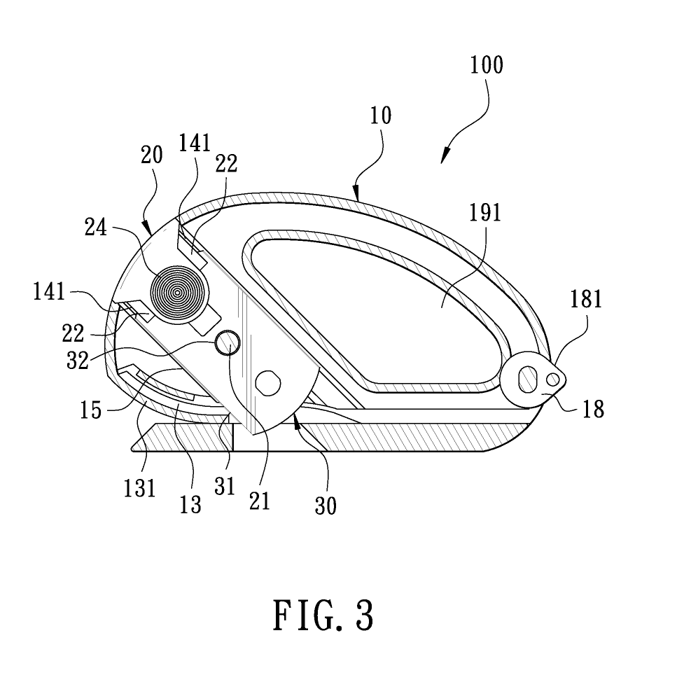

As shown in FIG. 1 to FIG. 3, a letter opener 100 according to a preferred embodiment of the present invention comprises a main body 10, a fixing member 20, and a blade 30.

The main body 10 has a top surface 11, a bottom surface 12, a cutting opening 13 disposed at a first end of the main body 10 close to the bottom surface 12 and extending toward a second end of the main body 10, and a notch 14 disposed close to the top surface 11 and extending toward the cutting opening 13. An inner wall of the notch 14 is formed with a pair of recesses 141. A trough 15 is formed between the cutting opening 13 and the notch 14. The trough 15 communicates with the cutting opening 13 and the notch 14. The main body 10 further comprises a resilient plate 131 disposed on an inner wall at one side of the cutting opening 13. The resilient plate 131 has a free end leaning against the inner wall at another side of the cutting opening 13. One side of the main body 10 is provided with a first guiding groove 16. One end of the first guiding groove 16 is connected to the cutting opening 13, and another end of the first guiding groove 16 is connected to the bottom surface 12 of the main body 10. Another side of the main body 10 is provided with a second guiding groove 17. One end of the second guiding groove 17 is connected to the cutting opening 13, and another end of the second guiding groove 17 transversely extends along the cutting opening 13 and is connected to the second end of the main body 10 opposite to the cutting opening 13. The second end of the main body 10 opposite to the cutting opening 13 is provided with a metallic plate 18. One end of the metallic plate 18 is exposed outside the main body 10 to form a triangular awl 181. The awl 181 has an arc tip, preventing the user from being hurt. Besides, the main body 10 has a through hole 191 disposed close to the top surface 11 to form a grip portion 19 for the user to hold the letter opener.

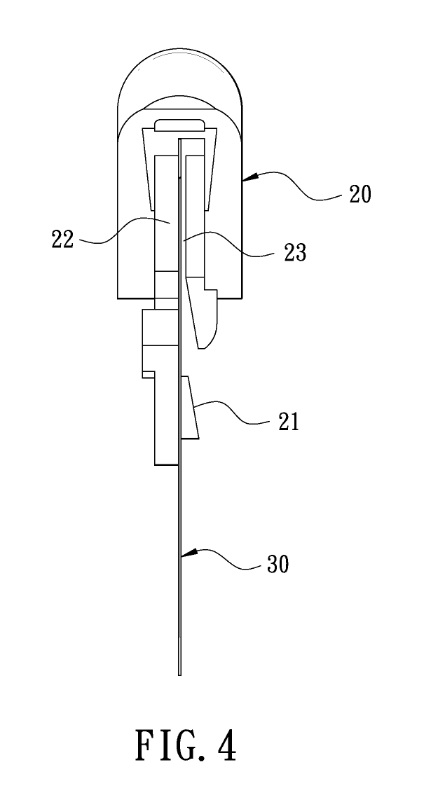

The fixing member 20 includes a positioning block 21 at one end thereof and an engaging portion 22 at an opposite end thereof. The fixing member 20 is secured in the notch 14 of the main body 10, and the positioning block 21 is inserted in the trough 15. In this embodiment, the engaging portion 22 of the fixing member 20 is a pair of protruding blocks corresponding to the pair of recesses 141 of the main body 10. As shown in FIG. 4, the fixing member 20 is formed with a clamping groove 23 facing the positioning block 21. Two opposite sides of the fixing member 20 are provided with a pair of skidproof portions 24. The skidproof portion 24 is constructed by a plurality of concentric circles for the user to hold the fixing member 20 to be inserted in the notch 14 of the main body 10 or pulled out from the notch 14.

The blade 30 has a pair of cutting edges 31 at two sides thereof. The blade 30 has a positioning hole 32 corresponding to the positioning block 21 of the fixing member 20, so that the blade 30 can be connected to the fixing member 20 and inserted in the through 15 of the main body 10 along with the fixing member 20. One of the pair of cutting edges 31 of the blade 30 is exposed in the cutting opening 13.

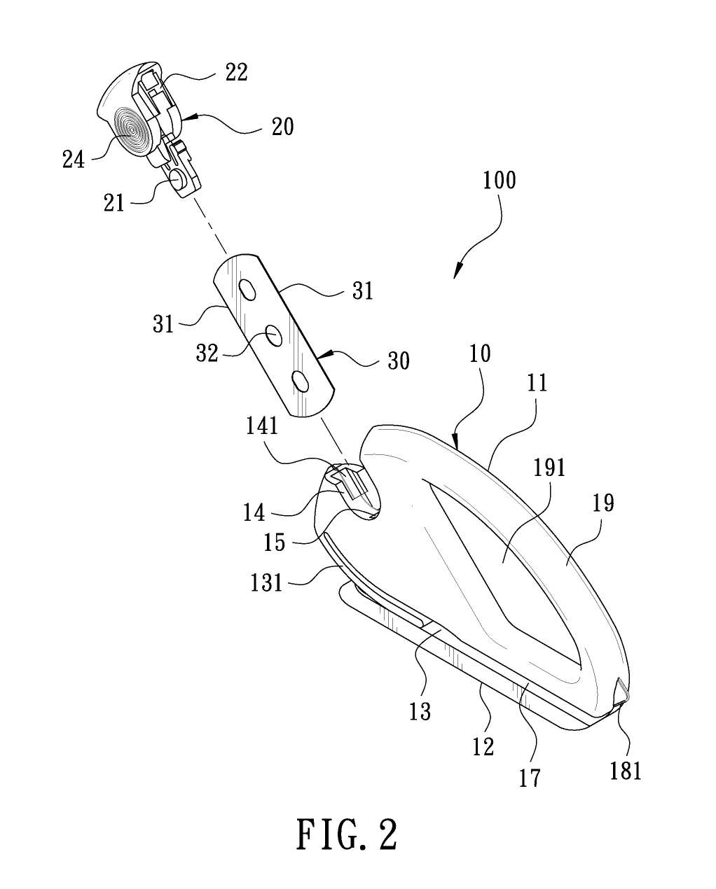

Referring to FIG. 2 and FIG. 4, before using the letter opener 100, the blade 30 must be mounted in the letter opener 100 first. As shown in FIG. 4, one end of the blade 30 is inserted in the clamping groove 23 of the fixing member 20, and the positioning hole 31 of the blade 30 is fitted on the positioning block 21 of the fixing member 20, such that the blade 30 is fixed to the fixing member 20. As shown in FIG. 2, the fixing member 20 is inserted in the notch 14 of the main body 10 and the pair of protruding blocks 22 is slid in the pair of recesses 141, so that the fixing member 20 is coupled to the main body 10. The blade 30 is accommodated in the trough 15 to prevent the user from being hurt when in use or during carrying.

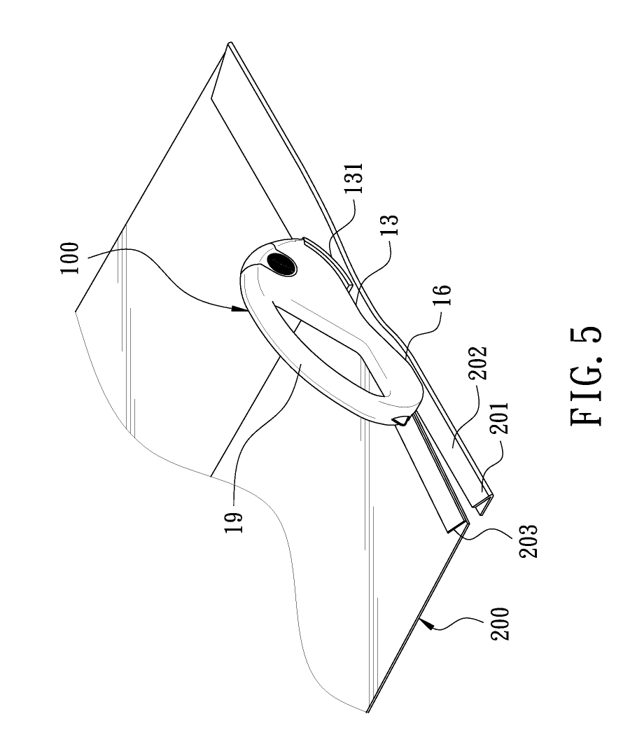

FIG. 5 is a schematic view showing that the letter opener 100 of the present invention is used to open an envelope 200. First, the user holds the grip portion 19 of the letter opener 100 with his/her fingers. The cutting opening 13 of the letter opener 100 is aimed at a sealed end 201 of the envelop 200 and pushed forward, so that the envelop 200 is clamped in an inner wall formed between the resilient plate 131 and the cutting opening 13 for the blade 30 to proceed to open the envelop 200. As shown in FIG. 5, when the envelop 200 is opened by the letter opener 100, the right half 202 of the cut envelop 200 is guided to bend downward by the first guiding groove 16, and the left half 203 of the cut envelop 200 is guided to pass through the letter opener 100 by the second guiding groove 17. Thus, the letter opener 100 can separate the cut portions of the envelop 200 with ease to enhance work efficiency.

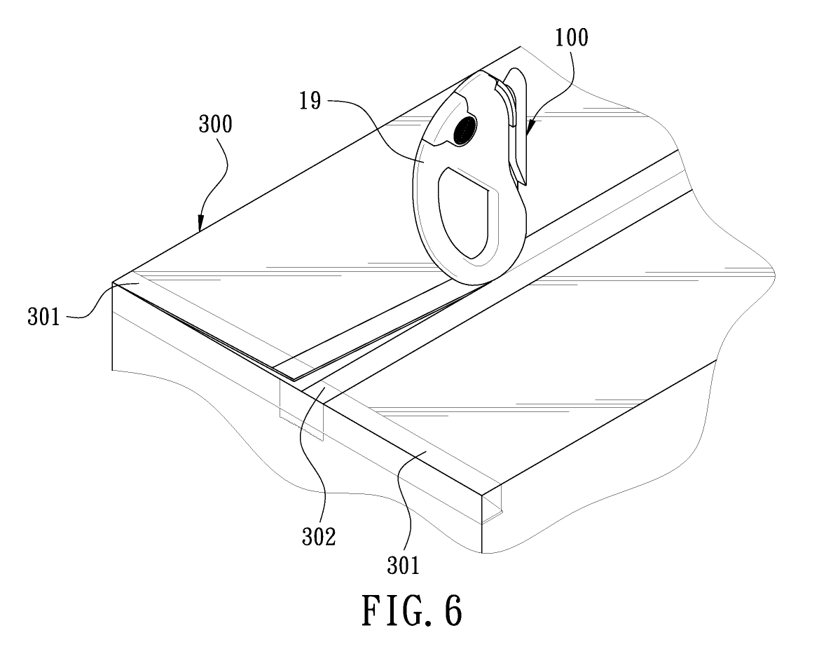

FIG. 6 is a schematic view showing that the letter opener 100 of the present invention is used to open a carton 300. The awl 181 of the metallic plate 18 at the second end of the letter opener 100 is aimed at the joint of two side boards 301 of the carton 300 to cut an adhesive tape 302 on the carton 300, so that the carton 300 is opened. Accordingly, the letter opener 100 of the present invention can be used widely.

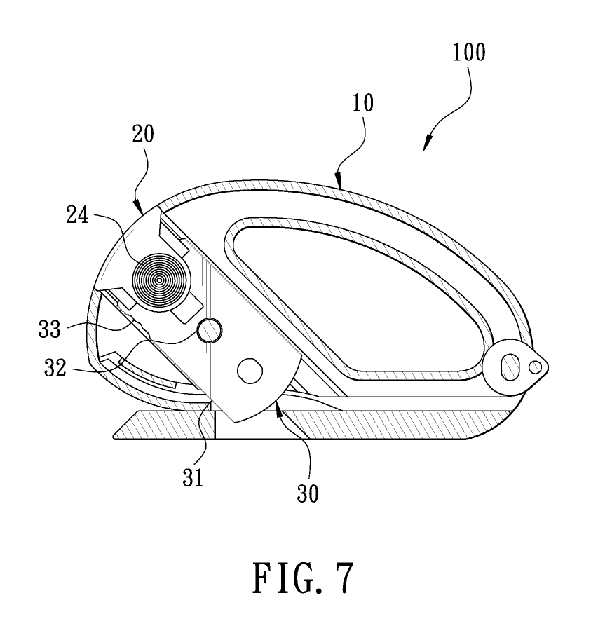

FIG. 7 is a schematic view showing that the blade 30 of the present invention can be reversed. The blade 30 has the cutting edges 31 at both sides. The cutting edge 31 may be blunt or have a dent 33 after using a period of time. The user can hold the skidproof portions 24 of the fixing member 20 to disengage the fixing member 20 from the notch 14 and take out the blade 30, and then both ends of the blade 30 are exchanged. The blade 30 is connected to the fixing member 20 again, and then the fixing member 20 is inserted in the notch 14 of the main body 10. As shown in FIG. 7, the undamaged cutting edge 31 of the blade 30 can be used to cut. When the cutting edge 31 at one side of the blade 30 is damaged totally, the blade 30 can be taken out and reversed so that the cutting edge 31 at the other side of the blade 30 is exposed from the cutting opening 13 for cutting. Therefore, the blade 30 can be replaced with a new one after four changes of position, which is cost-effective. In addition, it is only required to replace the blade 30, without throwing away the main body 10. The letter opener 100 of the present invention is environmentally friendly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A letter opener, comprising:
a main body having a top surface, a bottom surface, a cutting opening disposed at one end of the main body close to the bottom surface, a notch disposed close to the top surface, and a trough disposed between the cutting opening and the notch, the trough communicating with the cutting opening and the notch;
a fixing member including a positioning block at one end thereof and an engaging portion at an opposite end thereof, the fixing member being secured in the notch of the main body, the positioning block being inserted in the trough; and
a blade having a pair of cutting edges at two sides thereof, the blade having a positioning hole corresponding to the positioning block of the fixing member for the blade to be connected to the fixing member and inserted in the through of the main body along with the fixing member, one of the pair of cutting edges of the blade being exposed in the cutting opening;
thereby, when the cutting edges of the blade are abraded, the blade being replaced with a new one by disengaging the fixing member from the notch.

2. The letter opener as claimed in claim 1, wherein one side of the main body is provided with a first guiding groove, one end of the first guiding groove being connected to the cutting opening, another end of the first guiding groove being connected to the bottom surface of the main body, another side of the main body being provided with a second guiding groove, one end of the second guiding groove being connected to the cutting opening, another end of the second guiding groove transversely extending along the cutting opening and being connected to another end of the main body opposite to the cutting opening.

3. The letter opener as claimed in claim 1, wherein another end of the main body opposite to the cutting opening is provided with a metallic plate, one end of the metallic plate being exposed outside the main body to form a triangular awl, the awl having an arc tip.

4. The letter opener as claimed in claim 1, wherein the main body has a through hole disposed close to the top surface to form a grip portion.

5. The letter opener as claimed in claim 1, wherein the main body comprises a resilient plate disposed on an inner wall at one side of the cutting opening, the resilient plate having a free end leaning against the inner wall at another side of the cutting opening.

6. The letter opener as claimed in claim 1, wherein an inner wall of the notch is formed with a pair of recesses, the engaging portion of the fixing member being a pair of protruding blocks corresponding to the pair of recesses of the main body.

7. The letter opener as claimed in claim 1, wherein the fixing member is formed with a clamping groove facing the positioning block.

8. The letter opener as claimed in claim 1, wherein two opposite sides of the fixing member are provided with a pair of skidproof portions, each of the skidproof portions being constructed by a plurality of concentric circles.
